(19) United States
(12) Patent Application Publication
(10) Pub. No.: US 2014/0019264 A1
(43) Pub. Date: Jan. 16, 2014

(54) FRAMEWORK FOR PRODUCT PROMOTION AND ADVERTISING USING SOCIAL NETWORKING SERVICES

(71) Applicant: Ditto Labs, Inc., Cambridge, MA (US)

(72) Inventors: Joshua Seth Wachman, Newton, MA (US); David Loring Rose, Brookline, MA (US)

(73) Assignee: Ditto Labs, Inc., Cambridge, MA (US)

(21) Appl. No.: 13/888,268

(22) Filed: May 6, 2013

Related U.S. Application Data
(60) Provisional application No. 61/850,702, filed on Feb. 22, 2013.
(60) Provisional application No. 61/687,998, filed on May 7, 2012.

(51) Int. Cl. G06Q 30/02

(52) U.S. Cl. CPC G06Q 30/0276
USPC 705/14.72

(57) ABSTRACT

A method includes acquiring an image from a user; analyzing the image to determine whether it includes information associated with a brand reference; producing an augmented image based on the image; and posting the augmented image to a social networking service (SNS) associated with the user. The augmented image may include a graphical overlay, a frame, a comment, and a hyperlinked textual comment, cropping of the image, blurring a portion of the image, applying a spotlighting effect to a portion of the image. The method may determine a measure of influence of a user on a brand based on a number of interactions by other users with the augmented image; and a number of images posted by the user that are associated with the brand.

### RELATED APPLICATIONS

This patent application is related to and claims priority from: (1) U.S. Provisional Patent Application No. 61/687,998, titled “Method for promoting products and services in a peer to peer framework through personal photographs,” filed May 7, 2012; and (2) U.S. Provisional Patent Application No. 61/850,702, titled “Method for establishing and displaying the sentiment and influence of people for a brand, location, product, service or experience in peer to peer networks through shared photographs,” filed Feb. 22, 2013, the entire contents of each of which are fully incorporated herein by reference for all purposes.

### BACKGROUND OF THE INVENTION

### Copyright Statement

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to product promotion and advertising. More particularly, this invention relates to a framework of computer-related systems, devices, and approaches to product promotion and advertising using peer networks such as social networking services.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 shows an overview of a framework according to embodiments hereof;

FIG. 2 depicts exemplary aspects of image metadata according to embodiments hereof;

FIG. 3 is a flowchart of an exemplary flow according to embodiments hereof;

FIGS. 4(a)-4(c) depict images at various stages in the process shown in the flowchart in FIG. 3;

FIG. 5(a) depicts a collection of members of a social network having certain affinities according to embodiments hereof;

FIG. 5(b) depicts the collection of affinities of one member of the social network according to embodiments hereof;

FIGS. 5(c)-5(d) illustrate single images of a network member associated with a logo and various actionable links according to embodiments hereof;

FIG. 6 illustrates a measurement of smiles in an image according to embodiments hereof;

FIG. 7(a) depicts aspects of computing and computer devices in accordance with embodiments.

### DETAILED DESCRIPTION OF THE PRESENTLY PREFERRED EXEMPLARY EMBODIMENTS

### Background and Description

### Glossary and Abbreviations

As used herein, unless used otherwise, the following term or abbreviation has the following meaning:

SNS means Social Networking Service (e.g., Facebook, Twitter, Foursquare, Flickr, Linkedln and the like).

### Overview

In some aspects, the system provides a framework within which an image (e.g., a photograph) that is relevant to a company's brand may be associated with the company's products or services. As used herein, the term “brand” or “brand marketer” refers to an entity (e.g., a company) that provides an advertisement, coupon or offer or media to be associated with a user's image. As will be appreciated, this company may benefit from the association if spread or viewed by an audience.

As used herein, the term “image data” refers to information, preferably in digital form, representing one or more images or photographs. Image data may thus represent a single image or photograph or a series of multiple images (e.g., a video sequence). The term “image,” as used herein, may be used to refer to “image data,” and may thus also refer to a single image or photograph or a series of multiple images (e.g., a video sequence). A person acquiring an image via an image acquisition device (e.g., a camera) is referred to herein as a photographer. It should be understood, however, that the term “photographer” is not used to limit the type or nature of an acquired image. That is, a photographer may acquire (i.e., take) a photograph or a video image or any other kind of image.

The system enables a user (e.g., a photographer) to receive credit for taking and sharing a photo (preferably validated) in which an advertisement has been made on behalf of a brand. In addition the system enables people in the photographer's social network to receive benefit for viewing, and interacting with such an image.

Ad hoc and formal on-line social networks have emerged as new platforms for sharing life's events amongst individuals and groups. For example, on Facebook, the most popular social network today, more than 250 million photographs are uploaded each day. That number of images is equivalent to over a 1,000 two hour digital movies being uploaded daily. And as Facebook and other SNSs grow and digital photography becomes even more pervasive, that that number of images (and sequences of images) will likely increase. Unlike a digital movie, each image or video uploaded to Facebook likely has little correspondence to the next as they typically do not derive from a common story structure. Nevertheless, there may be commonalities that loosely connect clusters of images. These may include location, temporal coincidence and content. In this context the content of the image could be the celebration of a product or service or event. The framework described herein helps brands recognize this context and the latent advertising value therein.

The content of these myriad images document the mundane to the extraordinary; the profound to the profane. They capture facets of life in all its complexity. During prior decades when personal photographs were recorded on film and printed on paper, they were often squirreled away in envelopes and the proverbial shoebox under the bed. But today, with the ubiquity of network connectivity, cloud hosting and the extreme popularity of social media websites for social networking services (SNS) (such as Facebook, Flickr, Twitter, etc.), images reach networks of people with ease and speed. While the names of these social-networking entities and their relative cultural and business import may ebb over the coming decades, sharing images is a popular behavior that will endure and grow regardless of on-line platform.

Photographs may indicate the interest and attention of the photographer. Just as individuals express their interests and passions whenever they share with friends, family and colleagues in off-line social settings, so too, on-line photographs may capture indications of a photographer's passions. The system described here automatically matches attributes of a photograph with those features of potential interest to a given brand or brand category. The system may associate an advertisement, an offer, or additional media with each photograph in which those metadata are verified to exist so the photograph and its associated advertisement can be shared back in the context of and/or related to the ad hoc or formal social network. The framework requires metadata about an image in order to associate at least some of the image's content with a brand's advertisement.

In analyzing an image, it is useful to be able to determine at least some of the following information:
WHAT: “What” is the image about. “What” is in the image.
WHERE: “Where” was the image taken.
WHEN: “When” was the image taken.
WHO: “Who” took the image.

In preferred embodiments, the system may rely on the availability of various metadata attributes, including at least one of the following five metadata attributes:
(1) location (e.g., via geotagging) (answers “where”);
(2) time stamps (answers “when”);
(3) textual annotation (helps answer the “what” is going on or establishes context);
(4) personal (contributes to defining “who” is involved and their habits and behaviors and preferences); and/or
(5) image analysis (addresses another form of “what”).

Today, a deluge of brands fight for consumers' attention on billboards, radio, television, banner advertisements, etc. Techniques for rising above the noise are stale. Despite the cacophony, people find, identify with and celebrate their identities with brands. They freely advertise their brands by literally enveloping themselves in logos and paraphernalia using clothing, jewelry, lunch boxes, pins, bumper stickers, and the like. In this way people trumpet their affinity for a belief system, sports team, educational community, avocation, destination, lifestyle, political view or lifestyle fantasy, etc. Some even tattoo brands on their bodies. In this way they celebrate membership and telegraph their affinity to family, friends, and strangers.

Brand messages have traditionally been the province of corporate marketers who define and broadcast their brand's image. However today brands and their messages are reflected on-line where each brand becomes personified via social networking. This power shift occurred because of social media's rise. The consumer is often a brand messenger and the corporate marketer must struggle to embrace a new reality relegated to the programmer and market influencer.

On-line social networks (SNSs) as organized, e.g., by Facebook, Twitter, Foursquare, Flickr, email, LinkedIn and the like provide numerous platforms for individuals to share their brand passions, with the ubiquitous camera phone, telegraphing passions and consuming those of others is the new on-line norm with in this on-line connected context.

For marketers, word of mouth and viral advocacy are of premium value because they leverage the credibility of people you know and trust and are measurable and real time. For example, LinkedIn demonstrated the principal of qualifying and validating human resources within a user's network a more relevant and trusted perspective. The underling motivation is a psychological drive to build credibility with ones' peers.

Success means a user may burnish her personal brand, whereas failure may damage her relationship. A user hopes that her friends will have the same satisfaction with an experience as she did. She knows them well, so why not? When people accept a user's recommendation, it further validates that user's read of them and that user's choice and draws them closer. When individuals advocate to each other, they get the satisfaction of social capital reciprocity.

With on-line platforms organized around social communities, the popularity of loyalty programs and sophisticated image recognition, we invented a new brand currency that compensates your social network for your representation of any brand about which a user is passionate. The conduit of that advocacy is sharing an image on-line.

Each person is an ecosystem of preferences that may be expressed with images across media platforms. By posting images, an individual connects the brand marketer to their social network. Each brand benefits from an individual's advocacy this invention enables the social network members to benefit as well as the brand. It offers the marketer measurable means to participate and reward word of mouth advertising.

### DESCRIPTION

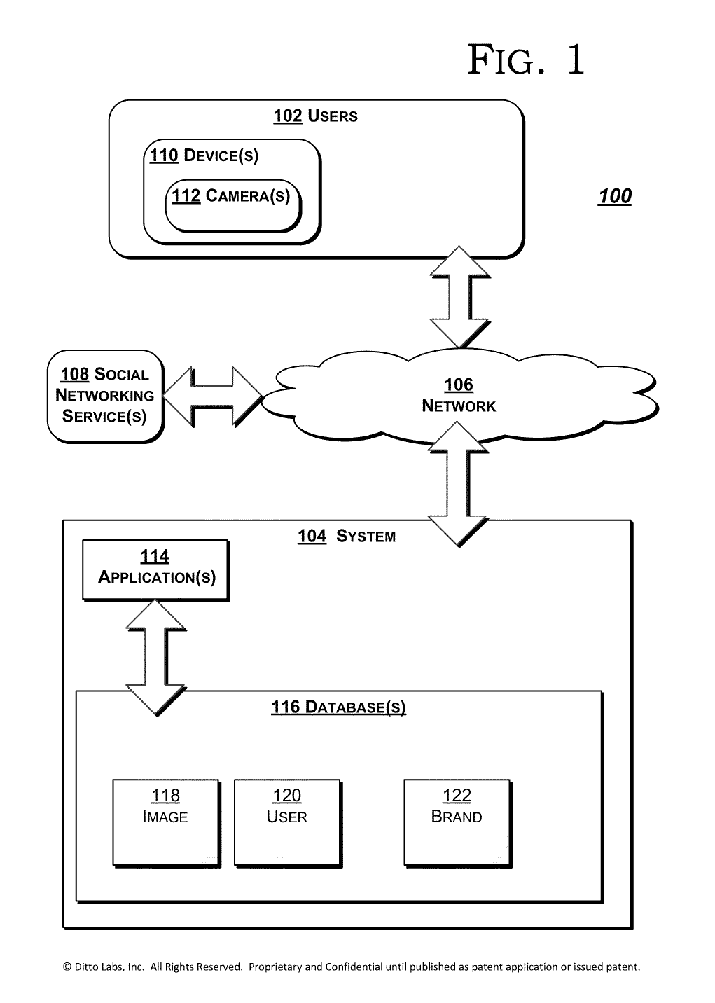

With reference to FIG. 1, in a framework 100 according to embodiments hereof, users 102 may access a system 104 via a network 106 (e.g., the Internet).

A particular user may have a relationship of some sort with other users, e.g., via a social networking service (SNS) 108. For example, a user may have a so-called “friends” relationship with other users via the Facebook SNS. It should be appreciated that a particular user may belong to multiple SNSs, and may have different relationships with other users in different SNSs. Those of ordinary skill in the art will realize and appreciate, upon reading this description, that the invention is not limited by the nature of users' relationships within any particular SNS.

A user 102 has a device 110 for acquiring image data. The device 110 preferably comprises a camera 112 or some other mechanism capable of image acquisition. It should be understood that the term “acquisition” may refer to selection of a previously taken image.

Image data may be stored in any known manner on a user's device 110, and the system is not limited by the manner in which images are acquired or stored on user devices.

The system 104 may comprise one or more servers and other/or other computers running application(s) 114 described herein. While showing in the drawing as part of system 104, it should be appreciated that the application(s) 114 may run at least in part on user devices 102. In particular, some image preprocessing may take place on a user's device 102.

A device 110 may be connectable to system 104 (directly or via other devices and/or network(s) 106) in order to transfer information (including image information) to the system 104 and to obtain information (including modified image information) from the system 104. For example, a device 110 may be a smartphone such as an iPhone or an Android device or the like with one or more cameras included therein. Such a device may be connectable to system 104 via a network such as the Internet and/or via a telephone system (e.g., a cellular telephone network). Alternatively, a device 110 may be a stand-alone camera that is connectable to the system 104 directly or via other devices and/or network(s) 106. A device 110 may store images, e.g., on a memory card or the like and the images may be provided to the system 104 in some manner independent of the device itself (e.g., via a memory card reader associated with a separate computer or the like).

Those of ordinary skill in the art will realize and appreciate, upon reading this description, that the framework 100 is not limited by the manner in which a device acquires image information (photographs or videos) or by the manner in which image information is provided to the system 104.

The application(s) 114 may access one or more databases 116, including an image database 118, a user database 120, and a brand database 122. It should be appreciated that databases may be implemented in any manner and that the system is not limited by the way in which databases are implemented. In addition, it should be appreciated that multiple databases may be combined in various ways.

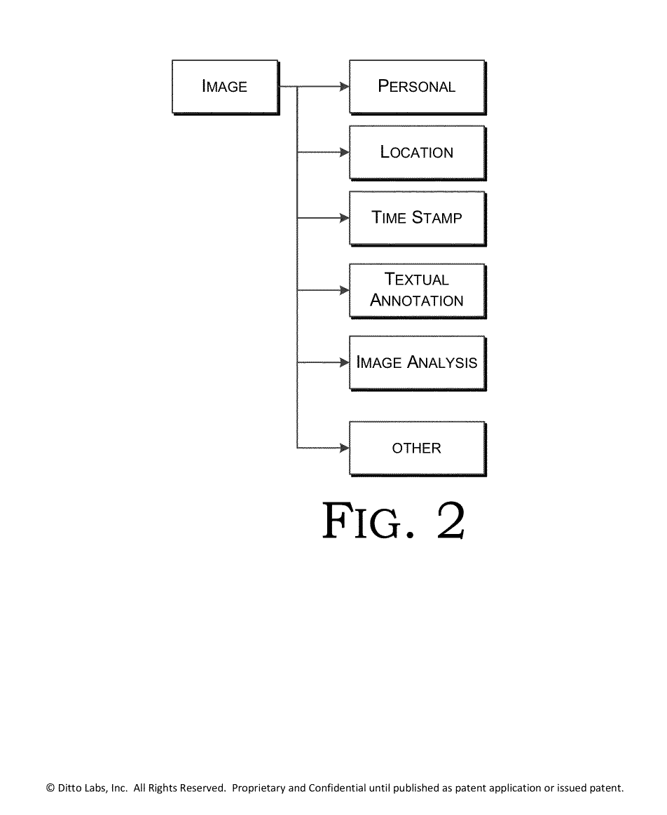

Image information may include image metadata. As explained herein, some image metadata may be provided by the device 110 that acquires the image (e.g., a camera, a smart phone, etc.) and some image metadata may be determined and/or provided by the system 104 with (or as part of) image information. Image information may be stored, at least in part, in image database 118. With reference to FIG. 2, the image metadata may include one or more of:
Location (e.g. geo-tag) information;
Time stamp information;
Textual annotation(s);
Personal information (e.g., owner information); and
Image-based feature analysis information.

Location (e.g., geo-tag) information may be provided by the device indicating a location (e.g., a geographic location) at which the corresponding image was acquired. For example, the device may include a GPS or the like and embed GPS-generated location information in the image data when an image is acquired. Geotagging is a common service available for mobile phones with embedded cameras (or cameras with network connectivity) where the location of the photograph is embedded in the image file itself like a time-stamp. It should be appreciated that the geo-tag meta information may be generated in any manner, including within the device itself or using one or more separate mechanisms, and the system is not limited by the manner in with geo-tag information is generated or associated with a corresponding image. It should further be appreciated that the geo-tag information may be of any resolution or granularity or precision (e.g., a street address, a suburb, a city, a store, a country, etc.) and that the system is not limited by the nature or resolution or granularity or precision of the geo-tag information provided with an image. It should still further be appreciated that different devices may provide geo-tag information (if at all) at different degrees of resolution/granularity/precision, and that the system does not expect or require that all devices provide the same type of geo-tag information or geo-tag information having the same nature or resolution or granularity or precision.

Timestamp information represents a time at which an image was acquired and may be included (or embedded) in image information. The timestamp information may be generated by the device (e.g., using a built in or network connected clock), or the user may set it. For example, when the device comprises a mobile phone or the like with a built-in or integrated camera, the timestamp information may be determined from the device's internal clock (which may, itself, determine the timestamp information from an external clock). A device may acquire or set the timestamp information automatically or it may require the user to set initial values for the time and then determine the timestamp information from those values using an internal clock. It should be appreciated that the system is not limited by the manner in which the timestamp information is determined or by how it becomes associated with an image. It should further be appreciated that the timestamp may have any granularity, and that the system is not limited by the granularity of the timestamp.

Textual annotations may be in an image title or a comment field associated with the images when a user (e.g., photographer) posts or saves the image.

Personal metadata is a derivative feature which evaluates the historical image posts of the user (e.g., photographer) and possibly that of their social network(s). Personal metadata may be predictive. Analyses which may contribute to the personal metadata may include an evaluation of one or more of:
frequency of the user posting images (e.g., mostly on weekend evenings); location or region where the user posts images (e.g., often within a stadium); and
contextual (e.g., a majority of the user's images are posted within the same hour as other friends within the social network in the same location (e.g., my friends like coffee shops in the morning, my friends were also at the concert)), etc.
Image-based feature(s) analysis (described in greater detail below).

Operation of the System

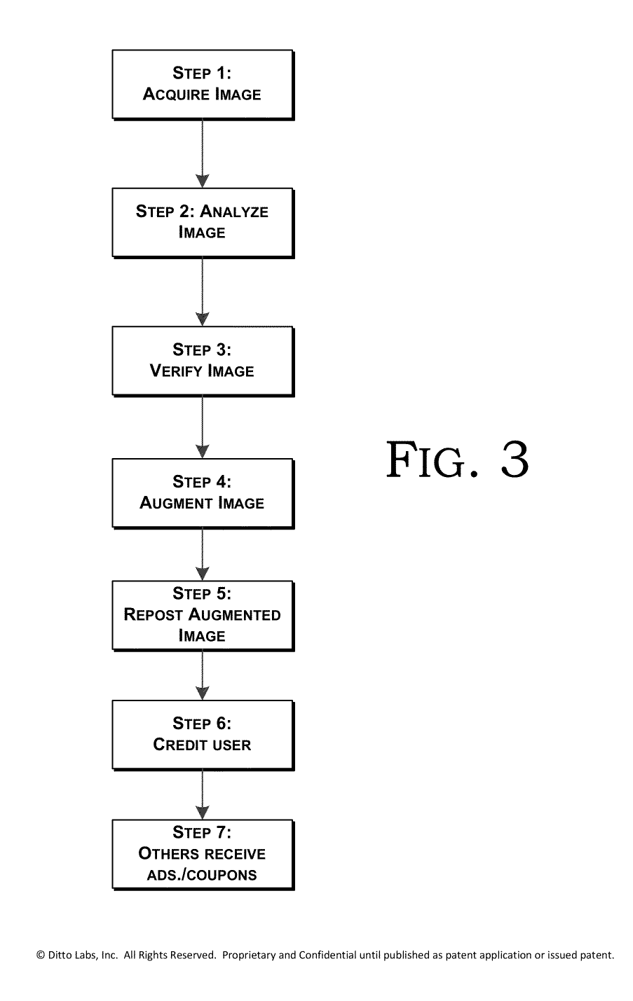

Operation of the system is described here with reference to FIG. 3.

Step 1: Acquire an Image

In using this system, a user 102 acquires an image. The user may use any device to acquire the image, including a camera, a smartphone or the like. The user may take a photograph (or video) using camera in a device or may use a previously acquired image.

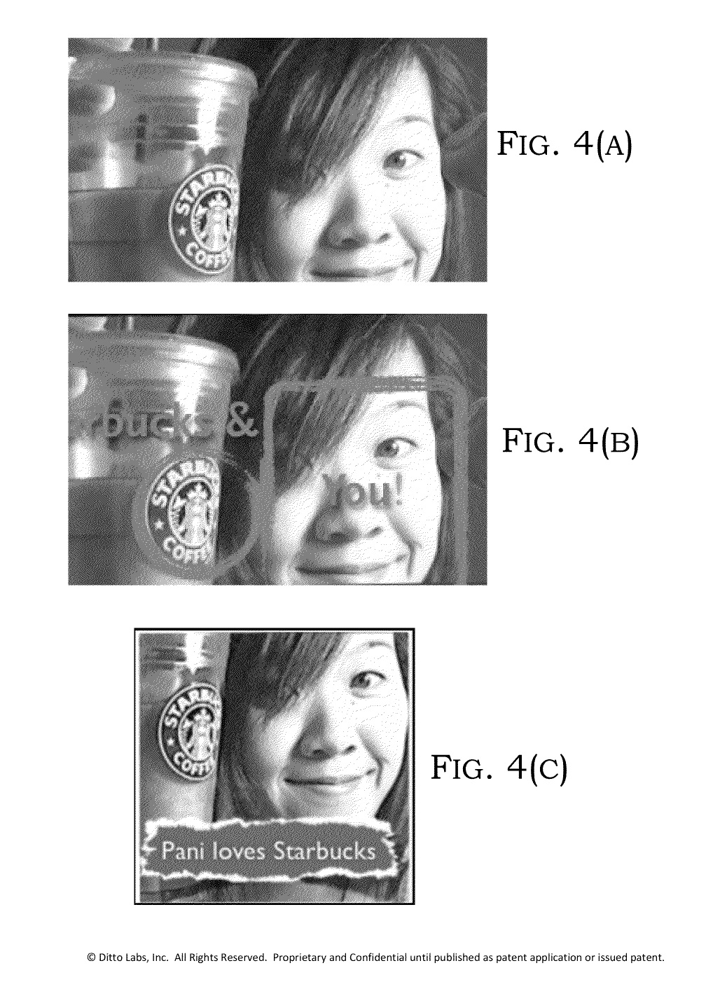

FIG. 4(a) shows an example image acquired by the user. As can be seen in the example image in FIG. 4(a), a person is holding up a cup with a Starbucks logo partially visible on the side of the cup.

Step 2: Analyze the Image

With reference again to FIG. 3, once acquired (in Step 1), the image is analyzed (in Step 2, as described here) in order to evaluate the image for at least some of the metadata attributes listed above. The image may be analyzed using application(s) 112 on the user's device 110 and/or in the system 104.

Recall from above the image metadata may include image-based features. Accordingly, in one aspect, e.g., the image may be analyzed to determine image metadata such as image-based feature analysis information.

Image-based feature analysis analyzes the content of an image in search of patterns that can be identified as relevant to a brand's interest.

As used herein, an “image feature” refers to a content-specific attribute of a user's image. This may include brand logos, text, products or other items of interest within the image. For example, in the image in FIG. 4(a), the Starbucks logo may be an image feature.

Image metadata include the descriptors listed above which characterize a user's image.

Brand attributes refer to a set of features defined by a brand or the parameters of a specific offer defined by a brand that makes a user's image verifiable. Brand attributes may comprise a list of features which may answer at least some of the “who?”, “where?”, “when?”, “what?” of the image as extracted from the metadata in the analysis stage detailed below.

Information about brand attributes may be stored in brand database 122 in the database(s) 116 of the system 104.

A “reference” (or “brand reference”) refers herein to a feature of a brand (e.g., a company name such as Starbucks), location of an establishment (e.g., inside the coffee shop), unique or trademarked product name (e.g., iPad), event window (e.g., during a Red Sox baseball game), etc. In the case of an image feature, the brand reference refers to a set of canonical images which may be distillations of or prime examples of the image feature of interest to the brand (e.g., Walt Disney's signature, Mickey Mouse's head, Tinker Bell's castle logo, etc.) or an instance of the iconic product (e.g., Ray-Ban sunglasses, a Coca Cola bottle, an Eames chair, etc.) Although various examples of brand references are given here as examples, it should be appreciated that the system is not limited by these examples or brands, and that different and/or other brands and brand references may be used and are contemplated herein.

The image-based feature analysis may, in some aspects, be considered to be similar to optical character recognition (in which letters of the alphabet are identified within a document to build a string of words for a virtual facsimile of a document. In some aspects, the image-based features analysis include words (e.g., the word “Nike” on a sign or tee shirt), brand logos (e.g., the MacDonald's golden arches), and canonical textual patterns (e.g., water, fire, sky, clouds, grass), faces (establishing identity which may be correlated to other instances within a cluster of images associated with the user's social network site(s) or portfolio of images), faces with smiles or other expressions (indicating the person's emotional state) and other identifiable items or products (e.g., sun glasses, hats, cars, watches, forest etc.).

Embodiments of the image-based feature analysis may use one or more well-established image recognition methods that take a training sample (e.g., a brand reference) and query a set of images returning a statistical likelihood whether or not a feature is present. Some of these well-known approaches include: Viola-Jones, cross correlation, and those detailed at:

Virtual Geometry Group, Dept. of Engineering Science, University of Oxford (http://www.robots.ox.ac.uk/˜vgg/research/)

The VLFeat open source library (http://www.vlfeat.org/)

The entire contents of each of these are fully incorporated herein by reference for all purposes.

The system may also use known methods optimized for facial feature analysis (e.g., Turk's “eigenfaces,” U.S. Pat. No. 5,164,992), for smile detection (e.g., U.S. Published Patent application no. US 20090002512 A1), for textual analysis (e.g., Picard and Minka's, Photobook).

The entire contents of U.S. Pat. No. 5,164,992, titled “Face recognition system,” are fully incorporated herein for all purposes.

Smile detection may use any known algorithm, e.g., the techniques described in U.S. Published Patent application no. US 20090002512 A1, titled “Image pickup apparatus, image pickup method, and program thereof,” the entire contents of which are fully incorporated herein by reference for all purposes.

Picard and Minka's research is published by MIT in the following technical reports, the entire contents of each of which are fully incorporated herein by reference for all purposes: (1) MIT TR#302: Vision Texture for Annotation, Rosalind W. Picard and Thomas P. Minka, also published as ACM/Springer-Verlag Journal of Multimedia Systems 3, pp. 3-14, 1995; (2) MIT TR#255: Photobook: Content-Based Manipulation of Image Databases, Alex Pentland, Rosalind W. Picard, Stanley Sclaroff, also published as IEEE Multimedia, Summer 1994, pp. 73-75; (3) MIT TR#215: Real-Time Recognition with the Entire Brodatz Texture Database, Rosalind W. Picard and Tanweer Kabir and Fang Liu, also published as Proc. IEEE Conf. Comp. Vis. and Pat. Rec., New York, N.Y., June 1993, pp. 638-639; and (4) MIT TR#205: Finding Similar Patterns in Large Image Databases, Rosalind W. Picard and Tanweer Kabir, also published as Proc. IEEE Conf. Acoustics Speech, and Signal Processing, Minneapolis, Minn., Vol. V, April 1993, pp. 161-164.

In addition, U.S. Pat. No. 6,711,293, “Method and apparatus for identifying scale invariant features in an image and use of same for locating an object in an image,” issued Mar. 23, 2004 is fully incorporated herein by reference for all purposes.

Preferred implementations of the system may use multiple object recognition algorithms rather than a single approach. Depending on which algorithm(s) is (are) employed for a given situation, a preprocessing step may be required to break the user's image into a set of tiles or tiles of various scales to measure the correlations to the brand reference.

Similarly standard means of preprocessing may include elimination of high frequency noise or elimination of chrominance to optimize the search.

If the necessary software exists on the user's device 102, at least some of the analysis may be performed locally on the device. Alternatively the image may be transmitted or uploaded to the system 104 (e.g., to a server in the system 104) where the analysis may be performed. It should be appreciated that analysis of an image may be performed in more than one location, and that a device supporting image analysis may still upload the image to the system 104 for at least some aspects of the analysis.

As noted above, a user may upload a previously acquired image. Thus, as should be appreciated, an existing portfolio of existing images (e.g., latent on a home computer) may be analyzed long after the images were captured. Those of ordinary skill in the art will realize and appreciate, upon reading this description, that the process described herein does not require real-time computation to be of business value.

Step 3: Verify the Image

With reference again to FIG. 3, with the image analyzed (in Step 2), the image is then preferably verified to confirm the results of the image analysis.

Those of ordinary skill in the art will realize and appreciate, upon reading this description, that in order to maintain the business value of the system to a brand marketer it is important that the output be robust. It is recognized that in some cases the analysis may return a result with low confidence. In such cases either a human judge or another automated image processing technique may be employed lest the image be falsely rejected or accepted. Thus, in some cases, controversial images returning low confidence may be reviewed by a human or panel of humans in a semi-assisted or unassisted process. Automated verification establishes that there is a statistically significant (above an adjustable threshold) correlation between the presence of metadata in the user's image and the brand attribute(s) of interest to a brand. It should be established that a confidence interval for any individual reference image may be established on a reference-image-by-reference-image basis. That is, the system may gather baseline statistics, where logos of different brands (e.g., a MacDonald's logo and a Nike logo) will have different levels of confidence.

The following table gives exemplary hypothetical verification data that may be used in an implementation. It should be appreciated that the data shown here are provided merely by way of example and are not meant to be in any way limiting of the system. Those of ordinary skill in the art will realize and appreciate, upon reading this description, that the system may use external input(s) such as a credit card purchase or the like.

| Image Metadata | Brand Attributes | Correlations |
|---|---|---|
| Time stamp | N/A | 0.00 |
| Location (latitude, | inside a Starbuck's store | 0.92 |
| longitude) | in Boston, Mass. | |
| Textual annotation | strings include “coffee” | N/A |
| | or “Starbucks” | |
| | (optional) | |
| Personal | user's first visit to a | 1.00 |
| | Starbucks store AND the | |
| | user's face must be | |
| | visible and smiling | |
| image feature | Starbucks logo | 0.77 |
| | recognized in the image | |
| at least two features be | at least two attributes | summary analysis |
| over 0.5 confidence to | must match over | photo is VERIFIED |
| proceed with analysis, | threshold of 0.75 to be | and the candidate |
| else discard image | verified by brand, else | image is accepted |
| | discard | |

If the image metadata are insufficient additional analyses may be made by iterating on the analysis with varying thresholds. Once the iterations are completed if an insufficient number of brand attributes are correlated, the image is rejected and the user is notified (if applicable) that the image is not a candidate for an advertisement. An image becomes a candidate if there are sufficient correlations to make the image verified. It then passes to the next stage.

FIG. 4(b) shows an example of the image of FIG. 4(a) with verification of various features. In particular, FIG. 4(b) shows the Starbucks logo and the person's identity are verified.

Step 4: Augment the Image

With reference again to FIG. 3, once verified (at Step 3), the image may be augmented (as described here) to produce a new (e.g., composite) image based on, and preferably including, the original image. The image may be augmented, e.g., to include advertising information and/or related media and/or links related to the brand(s) found in the image.

Thus, once the image is verified it may be marked. The actual marking is a design choice the brand or photographer can specify. Unlike traditional advertising this marking may be visually subtle so as not to diminish the personal relationship the user has with their audience.

Image augmentation(s) may include a graphical overlay, a framing, the amplification of the logo (if present), an automated comment (if within the context of a social network platform), a hyperlinked textual comment (if applicable), a renaming of the photograph's title, a cropping of the image, a blurring of the image, a spotlighting effect, reposting the image again to the same or other social network, a hyperlinking of the otherwise unedited image, etc. Those of ordinary skill in the art will realize and understand, upon reading this description, that an image may be augmented in multiple ways, and that the same type of augmentation may be used more than once in the same image. For example, an image may be augmented with multiple hyperlinks, while at the same time having a new title, some blurring, some cropping, and amplification of a logo. It should also be appreciated, that not all image augmentation need be immediately apparent or visible in the image. For example, a region of the image may be augmented to include a hyperlink which only becomes visible under certain conditions.

In addition to the design of the marking or hyperlinking being something the brand specifies, it also constitutes the advertising or can become a link to the advertisement. This could be a tender offer, the ability to “Like” (in the context of Facebook), the invitation for an email or coupon, the link to some video, the invitation to download a brand specific piece of software (app), the display of an automated caption (e.g., “Pani loves Starbucks” which itself is a hyperlink), etc.

The brand may create a set of offers or advertisements which are programmed to be associated with verified images. In the preferred embodiment of the invention the brand establishes a set of parameters and business rules to determine which offers get associated with which verified images. In some implementations, these parameters and rules and corresponding offers may be stored in the brand database 122. The parameters may key, e.g., off of the personal metadata of the user's image such as the demographics of the user or the demographics of the user's social network. In addition the structure of an offer itself may key off of this metadata (e.g., coupon good for limited time, for a limited geography, for the first X people to respond, for only first time interactions, etc.).

Those of ordinary skill in the art will recognize how to develop a parametrically defined list and selection criteria which optimize for these criteria based on attributes available in the metadata feature set of the image. FIG. 4(c) is an illustration of cropped and augmented user photo with an embedded hyperlink.

Step 5. The Augmented Image is Reposted

With reference again to FIG. 3, the augmented image (i.e., the image with modification of step 4 above) may be posted to one or more of the photographer's social networks or into an on-line forum (e.g., Twitter feed, photo sharing website, etc.)

Step 6. Credit User

With reference again to FIG. 3, the user is credited with uploading a verified image on behalf of the brand. The currency of these credits may be calculated based on an algorithm, which contemplates the user's clout or influence, the value of the promotion to the brand, geography, time-of-day, and other parameters.

Step 7.

Once a verified augmented image is uploaded (Step 5), a member of the social network who clicks on the image may be presented with the advertisement or coupon associated with the brand. The system may provide track-back links to quantify who was inspired by the augmented image to select a link. Links may be embedded into a hyperlink in an augmented image in order to support tracking and measurement.

A brand's agenda of measuring the impact of an advertisement within a social network is a valuable measure of the user's influence and an advertising campaign's efficacy.

The number of people who see and interact with a reposted image provides an additional important metric. Those of ordinary skill in the art of will know how to account for these threshold events to generate sufficient reports. In addition, these metrics may determine the value of the offer. For instance, the advertisement could be a coupon or a lottery for a free product. In this example, the number of people who interact with the advertisement may determine the coupon's value or the odds at winning the lottery. In addition, the timing of the interaction may be bounded by the brand (“good for one free coffee if redeemed within 24 hours”). Measurement may be considered a key component of the system. The overarching business goal of the system is to help brands empower their staunchest advocates via on-line word of mouth to influence their social network. So this step is the mechanism by which the brand rewards the social network for the user's advocacy. The brand may seek the social network member's personal information to redeem a coupon or could simply deliver some more traditional advertising (new product announcement, invitation to watch a movie trailer, etc.). The business promise of this invention is that the user gets the satisfaction of advocating for a product or service about which they are passionate and their social network members who interact with the personal photo that has been transformed into an advertisement receive some tangible premium offer for responding to their friend's (the user's) advocacy. The social network member is accepting the user's validation of the product or experience by interacting with the modified user's photo and receives a reward for doing so. The social network member's explicit or implicit (as automated) acknowledgement of this interaction builds social capital between the two people.

In some embodiments, when a social network member interacts with the advertisement in an image they are invited to use the software application that the original user used to post the image. If the audience member already has that software available to them then the fact that they clicked on the image automatically posts an augmentation to the user's photo within the context of their social network software or out of band via email. In this manner, the user gets some recognition that the image was interacted with by their audience.

In addition, the social network member's social network is notified that the user interacted with an augmented advertisement based on the original user's post. In this way the specific offer or advertisement can recurse or propagate through the social network where all the metrics captured above propagate cascading through the network via reposting, re-tweeting and if applicable emailing.

In another aspect, the system may provide methods or devices for establishing and displaying the sentiment and influence of people for a brand, location, product, service or experience in networks of their peers through shared photographs. It should be appreciated that, as used herein, a network of peers refers to a peers of a user. It should be understood that, as used herein, a network of peers does not refer to any underlying implementation of the network.

A photo posted by a SNS friend which includes the Starbucks logo or which was taken at a Starbucks coffee shop helps establish the friend's likely affinity for, or interest in, the Starbucks brand. More generally, the automated visual analysis of all photos posted by friends in a peer or social network may reveal a co-occurrence of logos or geolocations (by extension, geolocation may include a network of retail franchises as the plurality of Starbucks do not share the same raw geographical coordinates but do share logical membership in the Starbucks category of coffee shops) which establishes each individual's likely interest in the experience captured by their shared photo.

This approach aggregates sets of peers with shared affinities across a network. This is important as the photos and their related experiences constitute recommendations shared among peers. These images may be considered to be a type of word of mouth recommendation which is valuable to the network members. Network members may discover more about their peers' interests by interacting with the present invention. In addition, this aspect of the system offers commercial value to brands as a new form of advertising or as data required for more refined ad targeting.

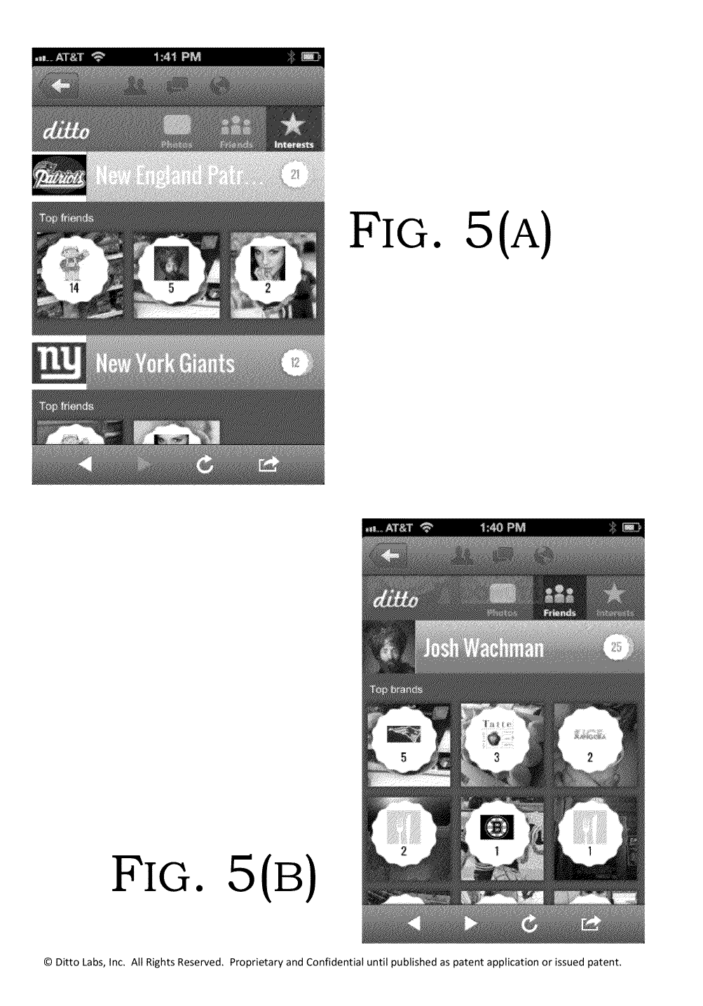

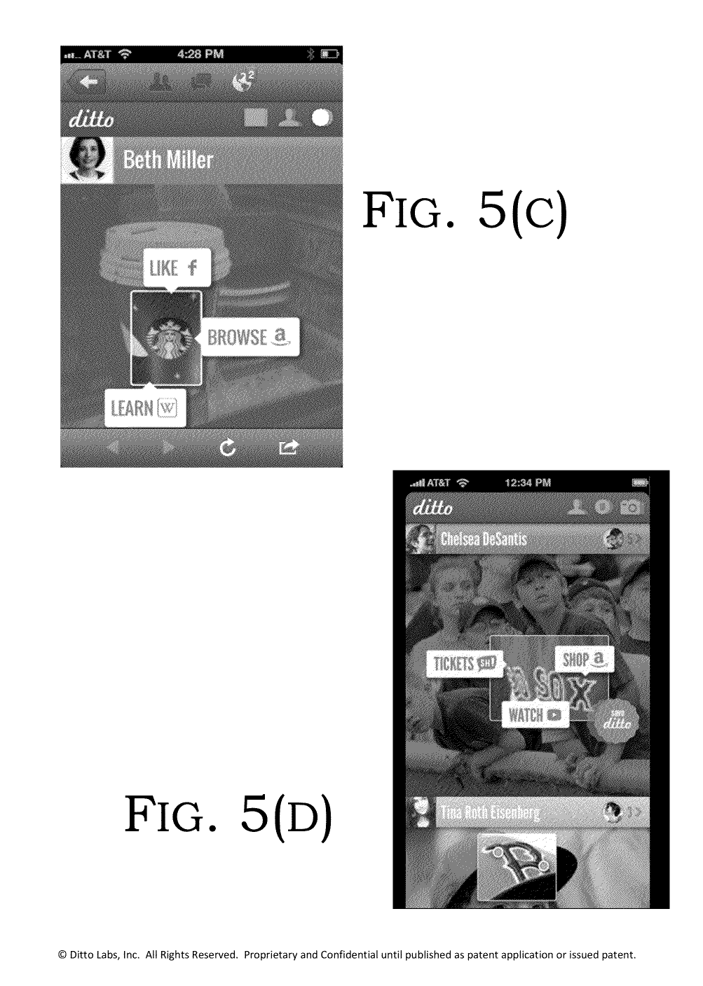

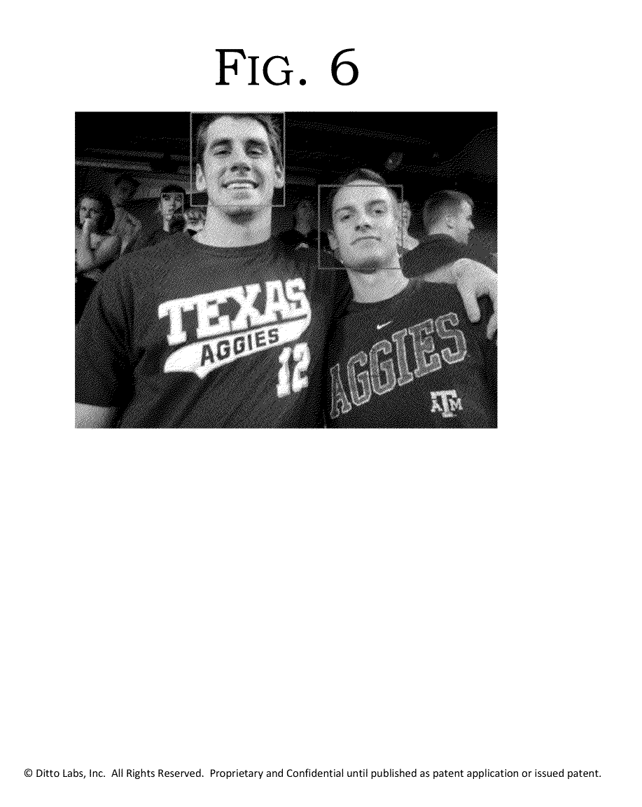

In some embodiments the system may support the display of image collections organized by shared affinity derived by metadata analysis. For instance, the system can identify and display images associated with Starbucks by friends who share that affinity. A logical pivot to this table of peers-by-affinity displays affinities-by-peers in the network. See, e.g., FIGS. 5(a) and 5(b). The image example in FIG. 5(a) shows a collection of thumbnail photographs of peers who share an affinity (in this example, the New England Patriots). As can be seen in FIG. 5(a), only three peers (“friends”), are shown. The image example in FIG. 5(b), on the other hand, depicts a collection of affinities of a single member of the network.

The system may make these collections interactive by standard means.

Users of the system may click on buttons in or around each image which enables them to delve deeper into media or engage in transactions related to the affinity. By these means the peer may share in the experience captured in the photo. Seem, e.g., FIG. 5(c), which illustrates a single photograph of a logo (the Starbucks logo) made interactive with actionable links to Browse, Learn and Like. The user may select any of those links in a known manner in order to browse, learn, or like, respectively. An actionable link may be a hyperlink or any other way of linking a user interaction with a region of an image. It should be understood and appreciated that a user's interaction with such a link may cause actions to take place on the user's device and/or remotely. For example, a user's selection of the “like” link may cause actions to take place within the corresponding SNS (Facebook). FIG. 5(d) shows another example of a photograph made interactive using actionable links.

While an image may be verified or verifiable because it contains a valid brand logo and prices other requirements for validity, there may be a number of reasons to use or not use a particular image. For example, an image containing an otherwise valid brand logo may include undesirable information such as a person frowning. On the other hand, an image with a valid brand logo may also include desirable information such as one or more people smiling.

Accordingly, in some embodiments, additional image metadata may be used as part of an image verification process.

The system detects faces and expressions as a form of metadata. Each smile in an image is treated as a unit of happiness, and all smiles counted in all photos shared in a network gives the network a smile score. By these means the system is able to report on which network has the happiest people and how this relative happiness is trending (both by network and by brand-experience).

As images are identified with brand or location associations, those images are recommendations for that brand or location. The system additionally may identify and associate the expressions detected in these images with these brands and locations. By these means we are able to report on which brands or locations have the happiest people.

As an example, the system may count the number of faces found in images taken at Starbucks store or with a Starbucks logo recognized in it. The system may then count how many of those faces are smiling. The system may display a quantized metric based on the quotient of smiles identified divided by all faces identified in a network. This is the smile score. This is a metric which the system may use to represent to users that is a proxy for how happy people are relating to Starbucks in the network. By extension system may calculate this across the entire pool of photos independent of network membership and then report a global metric of the relative happiness of people who visit Starbucks.

The system may also qualify this smile score by time, trend, location, etc. So it can indicate how happy are a user's friends who visit Starbucks this week, how people who visit there this week are happier than last week, and how one franchise location may be happier than another. The inventors believe that the smile score in a peer network is a unique and valuable metric which qualifies the recommendation previously specified.

The system may use the smile score as a metric in its calculation of influence of a person on a network or a network within all networks. The smile score may also impact the influence measure of brands and locations. A preferred embodiment of the invention may weight higher those people with more influence that are smiling at a particular location or proximal to a particular brand or location. Influence, absent the smile score, may be calculated several ways. The simplest measure of an individuals influence is a count of how many images the individual posts with a recognized brand or location as a function of their centrality to their network. Influence, and influence qualified by the smile score, are relative measures which have commercial value in the context of reporting to brands.

A user's influence may be determined based on the following equation:

points=influence×frequency×sentiment×social feedback/period×N

where:
influence is a proxy for the photographer's influence is the calculated, e.g., by eigenvector centrality (or one of several other measures in the literature);
frequency is a number of interactions with brand (by way of counting the incidence of photos with the brand, text mentions of brand or related key words or explicit actions like purchases related to the brand/product, click throughs on media related to the brand, queries (if available) on the brand/product);
period=unit of time;
sentiment=magnitude of smile on faces in the image as measured by published means;
social feedback=a measure of the number of comments, click throughs, re-sharing (reposting or re-tweeting), “Like”s visited on the photo by the photographer's friends;
N=a fractional score which normalizes the subject photo by all images of the brand or location or product across whatever data we have access to on relevant social media platforms.

Note that the smile score is a type of emotional sentiment but this technique is extensible to all facial expressions: frowning, laughing, crying, etc. It should be appreciated that emotional sentiment scores may be normalized by a count of all other incidences. So, e.g., the score of a person who smiles all the time (or of a person who never smiles) should preferably be normalized against their normal behaviors.

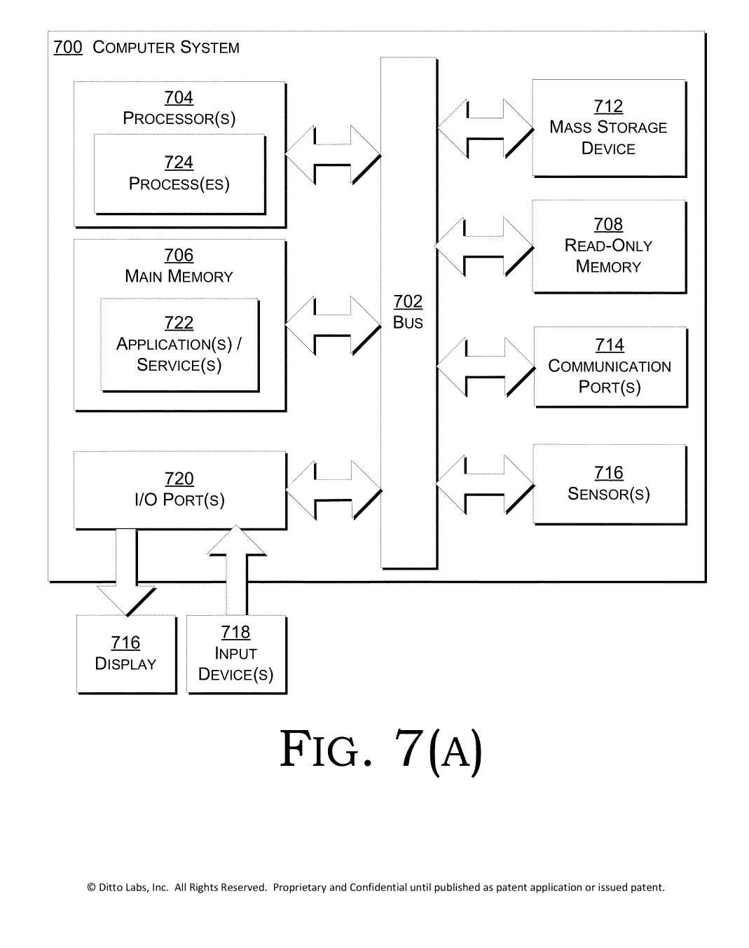

With reference to the photograph shown in FIG. 6, the square in the middle represents a face with smile recognized. The two squares on the left and right represent faces without smiles. For the team brand Texas Aggies found in this photo, the relative smile score would be ⅓ based on one smile in the three faces identified. This smile score qualifies this image but the technique may be applied to all Texas Aggie photos in the network or across all networks.

In some embodiments the relative size of a face or logo may be used as a filtering criterion. This approach deals with a scenario in an image where a person's head is so small it really isn't part of the composition. Such an approach will also deal with a scenario, e.g., where a user is in place with lots of logos (e.g., Time's Square) and a particular logo is barely visible overhead. In such scenarios a logo's relative prominence may not justify an affinity for the corresponding brand.

In some embodiments the system may eliminate or filter out noise (for at least some brands) require multiple incidences of a brand reference (in one or more images) before the system establishes affinity criteria. For example, the first photo with a Red Sox logo may not mean that a user is a fan, whereas the 5th may trigger an affinity. In some cases, when an affinity signal is weak, the system may look to qualify it (e.g., by other signals from text or hashtags or follow or “like” behaviors).

It should be appreciated that to the extent audio signals can also be identified with metadata and analysis, the system also covers the audio domain.

### Computing

The services, mechanisms, operations and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 7(a) is a schematic diagram of a computer system 700 upon which embodiments of the present disclosure may be implemented and carried out.

According to the present example, the computer system 700 includes a bus 702 (i.e., interconnect), one or more processors 704, one or more communications ports 714, a main memory 706, removable storage media (not shown), read-only memory 708, and a mass storage 712. Communication port(s) 714 may be connected to one or more networks by way of which the computer system 700 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 704 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 714 can be any of an RS-232 port for use with a modem based dial-up connection, a 10/100 Ethernet port, a Gigabit port using copper or fiber, or a USB port, and the like. Communications port(s) 714 may be chosen depending on a network such as a Local Area Network (LAN), a Wide Area Network (WAN), a CDN, or any network to which the computer system 700 connects. The computer system 700 may be in communication with peripheral devices (e.g., display screen 716, input device(s) 718) via Input/Output (I/O) port 720. Some or all of the peripheral devices may be integrated into the computer system 700, and the input device(s) 718 may be integrated into the display screen 716 (e.g., in the case of a touch screen).

Main memory 706 can be Random Access Memory (RAM), or any other dynamic storage device(s) commonly known in the art. Read-only memory 708 can be any static storage device(s) such as Programmable Read-Only Memory (PROM) chips for storing static information such as instructions for processor(s) 704. Mass storage 712 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 702 communicatively couples processor(s) 704 with the other memory, storage and communications blocks. Bus 702 can be a PCI/PCI-X, SCSI, a Universal Serial Bus (USB) based system bus (or other) depending on the storage devices used, and the like. Removable storage media 710 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 706 is encoded with application(s) 722 that support(s) the functionality as discussed herein (an application 722 may be an application that provides some or all of the functionality of one or more of the mechanisms described herein). Application(s) 722 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 704 accesses main memory 706 via the use of bus 702 in order to launch, run, execute, interpret or otherwise perform the logic instructions of the application(s) 722. Execution of application(s) 722 produces processing functionality of the service(s) or mechanism(s) related to the application(s). In other words, the process(es) 724 represents one or more portions of the application(s) 722 performing within or upon the processor(s) 704 in the computer system 700.

It should be noted that, in addition to the process(es) 724 that carries(carry) out operations as discussed herein, other embodiments herein include the application 722 itself (i.e., the un-executed or non-performing logic instructions and/or data). The application 722 may be stored on a computer readable medium (e.g., a repository) such as a disk or in an optical medium. According to other embodiments, the application 722 can also be stored in a memory type system such as in firmware, read only memory (ROM), or, as in this example, as executable code within the main memory 706 (e.g., within Random Access Memory or RAM). For example, application 722 may also be stored in removable storage media 710, read-only memory 708, and/or mass storage device 712.

Those skilled in the art will understand that the computer system 700 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

The system recognizes the growing popularity of digital photography, the fanatical devotion to on-line social media and recent strides in speed and efficacy of computer-based object recognition. The system leverages these trends to help companies promote their products and services via word of mouth advocacy in on-line forums.

The system described here helps consumers become better advocates for a set of products and services, and may be used to track, quantify and (in some cases) compensate consumers for those conversations.

Thus is provided a framework for product promotion and advertising using social networking services. The framework allows brand owners to answer some or all of the following types of questions:
PHOTO INSIGHTS
   What is the incidence of my brand in images and how is this trending?
   Where are these photos taken and when do people use my product?
   With what other products or brands does my brand or product commonly appear?
PEOPLE INSIGHTS
   Who takes photos where my brand appears?
   What are the characteristics of these people? (segmentation analysis: demographics,
   psychographics, technographics, PersonicX clusters)
   How does this community (by geography, time of use, etc.) compare with competitors?
   Who are the most influential brand champions (based on photos and network features)
   What is the sentiment associated with my brand (based on expressions of people in photos)
NETWORK INSIGHTS
   What is the size of network, centrality, virality, reach and topology of networks of my
   brand champions (how many friends know each other?).
   Which friends and followers are most likely to be susceptible to my brand champions?
   What photos are taken before or after the photos of my brand?

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

We claim:

1. A computer-implemented method comprising:
(A) acquiring an image from a user;
(B) analyzing the image to determine whether the image includes information associated with a brand reference;
(C) based on said analyzing, when it is determined that the image includes information associated with the brand reference,
(C)(1) producing an augmented image based on the image; and
(C)(2) posting the augmented image to a social networking service (SNS) associated with the user.

2. The method of claim 1 further comprising:
verifying the image prior to producing the augmented image.

3. The method of claim 1 wherein the augmented image comprises information from the image acquired from the user in (A) and one or more of:
a graphical overlay,
a frame,
a comment,
a hyperlinked textual comment.

4. The method of claim 1 wherein the augmented image is formed from the image acquired from the user in (A) by one or more of:
renaming of the image's title,
cropping of the image,
blurring a portion of the image,
applying a spotlighting effect to a portion of the image.

5. The method of claim 4 wherein the image acquired from the user in (A) includes a logo associated with the brand reference, and wherein the augmented image is formed from the image acquired from the user in (A) by amplification of the logo.

6. The method of claim 1 wherein the information associated with the brand reference comprises an image feature.

7. The method of claim 6 wherein the image feature comprises one or more of: a brand logo associated with the brand reference, text associated with the brand reference, and a product associated with the brand reference.

8. The method of claim 1 further comprising:
(D) crediting the user.

9. The method of claim 1 further comprising:
(E) crediting the user when other users of the SNS view or interact with the augmented image.

10. The method of claim 1 further comprising:
determining a measure of user sentiment associated with the image.

11. The method of claim 10 wherein the measure of user sentiment is based on facial expressions of people in the image.

12. The method of claim 11 wherein the measure of user sentiment is based on the number users smiling in the image relative to the number of users not smiling in the image.

13. A computer-implemented method comprising:
(A) acquiring an original image from a user;
(B) determining whether the original image includes information associated with a brand reference;
(C) using information in the original image to determine a measure of sentiment for the brand reference as reflected in the original image;
(D) based on said measure of sentiment and when it is determined that the original image includes information associated with the brand reference,
(D)(1) producing an augmented image based on the image;
(D)(2) posting the augmented image to a social networking service (SNS) associated with the user.

14. The method of claim 13 further comprising:
determining a measure of influence of the user on the brand based on one or more of:
(a) a number of interactions by other users with the augmented image;
(b) a number of images posted by the user that are associated with the brand.
